(19) United States
(12) Patent Application Publication
(10) Pub. No.: US 2012/0175283 A1
(43) Pub. Date: Jul. 12, 2012

(54) VESSEL INCORPORATING FILM WITH ENHANCED ANTI-STATIC PROPERTIES AND RELATED METHODS

(76) Inventors: Vishwas Pethe, Minneapolis, MN (US); Richard Bhella, Tempe, AZ (US); Steven Vanhamel, Hoegaarden (BE); Els Meesters, Hoegaarden (BE)

(21) Appl. No.: 13/496,282

(22) PCT Filed: Sep. 16, 2010
(86) PCT No.: PCT/US10/49098

§ 371 Date: Mar. 15, 2012

Related U.S. Application Data
(60) Provisional application No. 61/243,092, filed on Sep. 16, 2009.

(51) Int. Cl. B65D 85/00; B32B 27/06; B29C 47/00

(52) U.S. Cl. 206/524.9; 156/244.13; 428/516

(57) ABSTRACT

An apparatus for use in material processing takes the form of a vessel including a wall at least partially formed of a flexible film The film includes at least two layers having an anti-static agent and sandwiching an intermediate layer. Related methods are also disclosed.

This application claims the benefit of U.S. Provisional Patent Application Ser. No. 61/243,092, the disclosure of which is incorporated herein by reference.

### TECHNICAL FIELD

The present invention relates generally to the material processing arts and, more specifically, to a vessel incorporating a film with enhanced anti-static properties and related methods.

### BACKGROUND OF THE INVENTION

Many processing applications typically employ vessels for at least temporarily receiving and containing materials. For example, in the course of bioprocessing, hermetically sealable bags formed of flexible plastic film are often used for bulk intermediate storage, cell culture re-suspension, viral inactivation, final formulation, final fill, or as bioreactors. Typically, these bags are formed of a thin and flexible film, which may comprise one or more layers adapted to provide the vessel with particular characteristics (such as, for example, a particular degree of light/gas transmissivity or resistance to particle shedding).

Oftentimes, anti-static properties are a desirable characteristic for such a film when used in processing material susceptible to tribocharging, such as a powder or similar granular substance. The anti-static properties should remain intact during a relatively long storage period and thus would not impact the performance of a vessel incorporating the film when used after such storage. Stated another way, the properties should be stable in the sense that they would not dissipate through the surface of the film over time and ultimately vanish. Performance of the film in terms of its anti-static properties should also not be highly dependent on external factors, such as humidity, as may be the case with surface coatings or agents.

### SUMMARY OF THE INVENTION

One aspect of the disclosure relates to an apparatus for use in material processing. The apparatus comprises a vessel, such as a bag, including a wall at least partially formed of a flexible film. The film comprises at least one, and preferably at least two layers including an anti-static agent. In such case, the at least two layers sandwich an intermediate layer.

In one embodiment, the intermediate layer is thicker than one or both of the at least two layers including the anti-static agent. The at least two layers may comprise outer layers. The film may be transparent. Preferably but optionally, the film has a thickness of between about 100 and 250 microns.

Preferably, the anti-static agent comprises an ionomeric polymer and, most preferably, the anti-static agent comprises ENTIRA. The layers may each comprise polyethylene, and preferably but optionally, low density polyethylene. Most preferably but optionally, the intermediate layer comprises ultra-low density polyethylene.

The vessel may comprise a flexible bag including at least one port. The vessel may also include at least one weld for connecting a first portion of the film with a second portion of the film. Preferably, the weld bonds the intermediate layers of the first and second portions of the film.

Another aspect of the disclosure is an apparatus for use in material processing, in the form of a powder transfer vessel. The vessel includes a wall at least partially formed of a flexible film including at least one layer having a permanent anti-static agent and a port formed in the wall.

Still a further aspect of the disclosure relates to an apparatus for use in material processing. The apparatus comprises a vessel including a wall at least partially formed of a flexible film including at least one layer having a stable surface resistivity of less than about 10¹¹ ohm/square for a period of at least twelve months.

A further aspect of the disclosure relates to an apparatus for use in material processing, comprising a vessel including a wall at least partially formed of a flexible film. The film comprises at least two layers including an anti-static agent.

Still another aspect of the disclosure is a composition of matter comprising a film including at least two layers incorporating an anti-static agent and sandwiching an intermediate layer. Preferably but optionally, the film is animal derived component free.

Yet another aspect of the disclosure relates to an apparatus for use in material processing. The apparatus comprises a vessel including a wall at least partially formed of a flexible film. The film comprises an anti-static agent and is animal derived component free.

Another aspect of the invention pertains to a method of forming a vessel for use in material processing. The method comprises forming a wall of the vessel including a flexible film. The film comprises at least two layers including an anti-static agent. The at least two layers sandwich an intermediate layer.

The method may further include the steps of heating or applying pressure to the film. The method may also comprise welding the film. Preferably but optionally, the welding step is preceded by withdrawing the at least two layers to expose the intermediate layer, and then welding the intermediate layer.

An aspect of the disclosure also relates to a method related to the processing a granular material susceptible to tribocharging. The method comprises providing a vessel with an interior compartment bounded by a film including at least two layers comprising an anti-static agent.

The providing step may comprise welding the film to form the vessel. Preferably, the welding step comprises welding an intermediate layer of the film sandwiched between the at least two layers comprising the anti-static agent. Most preferably, the welding step is preceded by withdrawing the at least two layers to expose the intermediate layer. The providing step may further comprise extruding the film from a mixture of a polymer material and an anti-static agent as well as introducing the granular material to the interior compartment.

Yet a further aspect of the disclosure is a method of manufacturing a composition of matter, comprising forming a film comprising at least two layers including an anti-static agent sandwiching an intermediate layer. The forming step may comprise extruding the film, and the method may further include the step of welding the film. Preferably but optionally, the welding step comprises welding the intermediate layer of the film. Most preferably but optionally, the welding step is preceded by withdrawing the at least two layers to expose the intermediate layer.

Still another aspect of the disclosure is a method of manufacturing a composition of matter, comprising: (1) providing a first film comprising a first layer and a second layer including an anti-static agent, said second layer covering a surface of the first layer; (2) exposing the surface of the first layer; and (3) welding the first layer. Preferably but optionally, the welding step comprises welding the first layer to a second film. Most preferably but optionally, the providing step comprises providing the first film having a third layer including an anti-static agent.

### BRIEF DESCRIPTION OF THE DRAWING FIGURES

FIG. 1 illustrates in partial cross-section a vessel including the anti-static film in accordance with the disclosure; and

FIG. 2 is a schematic view of one possible embodiment of the film.

### DETAILED DESCRIPTION OF THE INVENTION

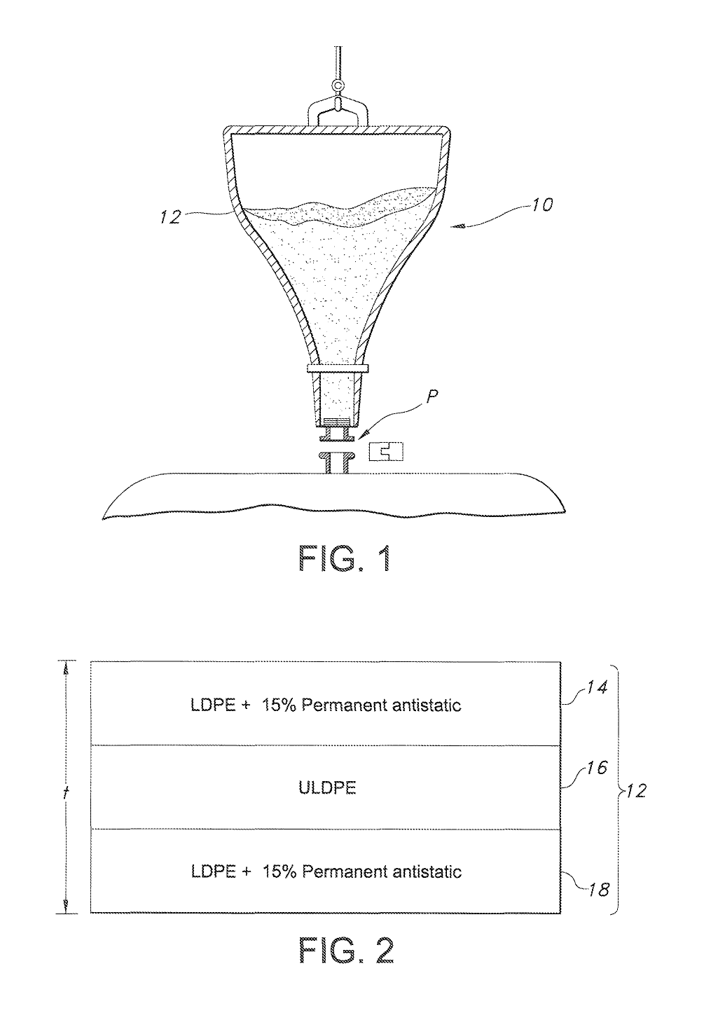

Reference is now made to FIG. 1, which illustrates a vessel 10 according to one aspect of the disclosure. Preferably, this vessel 10 is a bag of the disposable or single-use type typically used in processing materials under sterile conditions, such for preparing biological agents, pharmaceutical preparations, or the like. In the most preferred embodiment, the vessel 10 comprises at least one wall made of a thin, flexible film 12. This construction results in a vessel 10 that can be folded and, when filled, may adapt to the shape dictated by whatever is contained in the interior compartment.

In one embodiment, a port P may also be providing for feeding, transmitting or transferring a flowable material, such as for example a granular substance or powder, to and from the interior compartment, which may be defined by corresponding seals formed by bonds or welds in one or more sidewalls of the vessel 10. In the case where powder is contained, the vessel 10 may be considered a powder feed or transfer bag for delivering the powder to a vessel in which fluid processing is being completed. The port P may be associated with a removable closure or cap, and may also be provided with a connector for connecting with a second vessel for receiving the contents of the vessel 10, as shown in FIG. 1.

The film 12 forming the vessel 10, such as bag, is adapted to provide anti-static properties along the surface bounding the interior compartment. This is accomplished by forming the film 12 comprising at least one layer including a permanent anti-static agent. The anti-static agent maintains a surface resistivity along the interior compartment of the vessel 10 bounded by the film 12 of less than or equal to about 10¹¹ ohm/square for a period of at least twelve months.

Preferably, the film comprises multiple discrete layers and, most preferably, at least three contiguous layers 14, 16, 18. As schematically illustrated in FIG. 2, the film 12 in this most preferred embodiment comprises first and second layers 14, 18 incorporating the anti-static properties that sandwich an intermediate or middle layer 16 that does not include such properties and is thus “regular” in terms of its material composition. Most preferably, the vessel 10 consists essentially of this film, meaning that it does not include any additional layer that alters the basic properties of the film comprised of layers 14, 16, 18.

The film 12 may be comprised of inert, biocompatible materials, such as polymers. Preferably but optionally, the film 12 comprises polyethylene. Most preferably but optionally, layers 14, 18 are the outermost layers of the film 12, as shown, and comprise low density polyethylene (LDPE) or a blend of LDPE and other materials. The intermediate layer 16 may comprise LDPE, but most preferably comprises ultra-low density polyethylene (ULDPE) or a blend of ULDPE and other materials.

The thickness of the film 12 may range from about 100-250 microns (note dimension t in FIG. 2). Outer layers 14, 18 comprise a minority of the thickness. For example, each of layers 14, 18 preferably comprises less than about 30% of the total thickness of the film 12, and most preferably 15-20%. The intermediate layer 16 forms the remainder and, most preferably, the majority of the film, since the anti-static agent is more costly and thus should be provided as judiciously as possible while achieving the desired benefits. As an example, the thickness of the intermediate layer may be about 150 micron, with the outer layers each having a thickness of about 45 micron, for a total thickness of film 12 of about 240 micron. To allow for visual perception of the contents, the film 12 is also preferably at least translucent and, most preferably, transparent.

Co-extrusion techniques may be used to form the film 12 having the three layers of the same or different composition. Specifically, the selected polyethylene materials may be introduced in pellet form to an extruder for simultaneously extruding the film 12 comprised of the at least three layers 14, 16, 18. An exemplary device used in performing the extrusion may be an OMICRON co-rotating twin screw extruder distributed by STEER. Preferably, the extrusion is done at a temperature of between about 185° C.-215° C. and, most preferably, about 200° C. The thickness settings of the extruder head correspond to the desired thickness of the layers 14, 16, 18.

The anti-static properties may be provided to the film 12 by blending an anti-static agent into the polymer material. Preferably but optionally, the anti-static agent comprises an ionomeric polymer material comprising an inorganic pigment, such as titanium dioxide and treated with a siloxane-based compound or “silanized.” Such an agent is distributed by DuPont under the brand ENTIRA (and, most preferably, that distributed as ENTIRA SD 100). This agent may be incorporated into the material prior to extrusion by mixing, and may also be provided in pellet form for mixing with the selected polymer pellets forming layers 14, 18. Preferably but optionally, the anti-static agent comprises less than 20% by weight of the material used for forming each layer incorporating the agent, such as layer 14 or layer 18, and most preferably between 1-15% by weight.

To form the vessel 10, the film 12 may be extruded in tube form, and cut to predetermined lengths. One or both open ends of the tubular film 12 may then be bonded to form the interior compartment. Preferably but optionally, the bonding is achieved by the application of heat and pressure to opposed regions of two layers of the film 12, which results in at least two of the layers bonding with each other. In one embodiment, the bond is between the outer layers 14, 18 of different portions of the film 12. Alternatively, the bond may be formed between the intermediate layers 16 of different portions of the film 12 by welding such that a portion of the material of one of these layers 16 melts to form the desired bond. In this case, the welding is most preferably done with the outer layers 14, 18 withdrawn, pushed back, or otherwise manipulated to expose the intermediate layer 16. When the intermediate layers 16 of two different portions of the film 12 are welded in this manner, a secure, permanent bond results that is not in any way compromised by the presence of the anti-static agent in the other layers of the film 12. In any case, the bonding thus defines the interior compartment of the vessel 10 and creates a corresponding hermetic seal.

Several advantages may result from forming the vessel 10 in the foregoing manner. For instance, the spaced apart outer layers 14, 18 of the film 12 incorporate the anti-static agent in a permanent fashion, which means it is not subject to dissipation over reasonable periods of time. This results in a vessel 10 that is stable in the sense that it maintains a surface resistivity along the interior compartment bounded by one of these layers 14 or 18 of less than or equal to about 10¹¹ ohm/square for a period of at least twelve months. This permanency and stability provides the vessel 10 incorporating the film 12 with a relatively long shelf life, as compared to dissipative-type films in which the anti-static properties vanish over periods as short as six months. Bounding the interior compartment in this manner also avoids problems associated with powder attraction and collection at the surface of the film 12. The use of a blended anti-static agent, as opposed to a surface coating, also reduces or eliminates the effects of humidity on performance. The lack of an agent or coating applied to the film 12 also helps to ease the manner in which it is bonded together, such as by welding, and also results in a seal of improved strength and integrity.

Preferably but optionally, the film 12 is manufactured so that it is animal derived component free (ADCF). Thus, the ADCF-free film 12 having at least one layer including a permanent anti-static agent may be used to form a vessel 10, such as a bag. Also, the film 12 should meet or exceed certain cleanliness requirements of the life sciences industry. The particle count of the film 12 is kept low due to the particles being chemically linked to the resin and not apt to migrate out of the film, and is thus USP VI compliant. Hence, the film 12 is considered to be of medical grade.

The foregoing descriptions of various embodiments of the invention are provided for purposes of illustration, and are not intended to be exhaustive or limiting. Modifications or variations are also possible in light of the above teachings. The embodiments described above were chosen to provide the best application to thereby enable one of ordinary skill in the art to utilize the disclosed inventions in various embodiments with various modifications as are suited to the particular use contemplated. All such modifications and variations are within the scope of the invention.

1. An apparatus for use in material processing, comprising:
a vessel including a wall at least partially formed of a flexible film, said film comprising at least two layers including an anti-static agent, said at least two layers sandwiching an intermediate layer.

2. The apparatus of claim 1, wherein the intermediate layer is thicker than one or both of the at least two layers including the anti-static agent.

3. The apparatus of claim 1, wherein the at least two layers comprise outer layers.

4. The apparatus of claim 1, wherein the vessel comprises a flexible bag including at least one port.

5. The apparatus of claim 1, wherein the vessel includes at least one weld for connecting a first portion of the film with a second portion of the film.

6. The apparatus of claim 5, wherein the weld bonds the intermediate layers of the first and second portions of the film.

7. (canceled)

8. The apparatus of claim 1, wherein the anti-static agent comprises an ionomeric polymer.

9. (canceled)

10. The apparatus of claim 1, wherein the layers each comprise polyethylene.

11. (canceled)

12. The apparatus of claim 1, wherein the intermediate layer or layers comprise ultra-low density polyethylene.

13-16. (canceled)

17. A composition of matter comprising a film including at least two layers incorporating an anti-static agent and sandwiching an intermediate layer.

18-24. (canceled)

25. A method of processing a granular material susceptible to tribocharging, comprising:
providing a vessel with an interior compartment for receiving the granular material, said interior compartment bounded by a film including a permanent anti-static agent.

26. The method of claim 25, wherein the providing step includes welding the film.

27. The method of claim 25, wherein the welding step comprises welding an intermediate layer of the film sandwiched between at least two layers comprising the anti-static agent.

28. The method of claim 27, wherein the welding step is preceded by withdrawing the at least two layers to expose the intermediate layer.

29. The method of claim 25, wherein the providing step comprises extruding the film from a mixture of a polymer material and an anti-static agent.

30. The method of claim 25, further including the step of introducing the granular material to the interior compartment.

31. A method of manufacturing a composition of matter, comprising:
forming a film comprising at least two layers including an anti-static agent sandwiching an intermediate layer.

32. The method of claim 31, wherein the forming step comprises extruding the film.

33. The method of claim 31, further including the step of welding the film.

34. The method of claim 31, wherein the welding step comprises welding the intermediate layer of the film.

35. The method of claim 31, wherein the welding step is preceded by withdrawing the at least two layers to expose the intermediate layer.

36-43. (canceled)

44. An apparatus for material processing, comprising:
a bag including a wall at least partially formed of a flexible film including at least one layer having a permanent anti-static agent.

45. The apparatus according to claim 44, wherein the at least one layer has a stable surface resistivity of less than about 10¹¹ ohm/square for a period of at least twelve months.

46-61. (canceled)
